(19) United States
(12) Patent Application Publication
(10) Pub. No.: US 2009/0171885 A1
(43) Pub. Date: Jul. 2, 2009

(54) EFFICIENT BULK LOAD

(76) Inventors: Adam Silberstein, San Jose, CA (US); Brian Cooper, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/965,714

(22) Filed: Dec. 27, 2007

(51) Int. Cl. G06F 17/30

(52) U.S. Cl. 707/2; 707/E17.048

(57) ABSTRACT

The subject matter disclosed herein relates to bulk loading of data into a database comprising a plurality of database partitions. In one particular example, the database partitioning may be revised before addition of the new data to the partitions.

### BACKGROUND

1. Field

The subject matter disclosed herein relates to bulk loading of databases.

2. Information

The updating of large databases with large amounts of new information presents challenges. In particular, the records in a large database may be stored in a plurality of partitions with one or more partitions being handled by a server that forms part of a server system. For example, if the key is an ISBN number for an edition of a book, one partition might contain records associated with ISBN numbers serving as a key, with the numbers falling, hypothetically, between 0-545-01022-5 and 0-546-05204-7. Where a data server 12 stores multiple partitions, the partitions may or may not contain data in which the key ranges are sequential. For example, for a server storing a partition with the aforementioned hypothetical key range, and a second partition, the key range of the second partition might not start where the key range of the first partition leaves off, but rather may be a range that is much higher or much lower than the key range of the first partition.

Such servers may each comprise a processor with its own input/output bus, random access memory (RAM) and a storage unit such as, for example, a hard disk drive, RAID array drive, solid state memory or some other form of long-term storage. The servers of the server system may be linked by a local area network (LAN), wide area network (WAN) or other network that links them together as part of the server system.

Bulk loading of data into the database may be accomplished by inserting new data into the appropriate partition handled by the appropriate server. As a partition reaches its maximum desired size, the partition may be divided into two parts, with each resulting partition being approximately half the size of the partition from which they were divided. After completion of the bulk loading process, the partitions may be balanced among the various servers of the server system. This may involve moving partitions from one server to another, shifting records from one partition to another to achieve partitions having desired size ranges, and otherwise seeking a uniform distribution of records and partitions across the servers of the server system.

While such a strategy is workable for additions of small numbers of records across the range of partitions comprising the database, the process becomes burdensome as the number of records to be loaded increases, as the task of balancing the database may involve the movement of large blocks of data between partitions and between servers.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic representation of a server system.

FIG. 2 is a flow diagram of an embodiment of a method of processing a bulk load new data into a database.

FIG. 3 is a flow diagram of an embodiment of a method for information gathering in connection with a bulk loading of new data into a database.

FIG. 4 is a flow diagram of a method for creating a partitioning scheme to which new data can be added.

FIG. 5 is a chart showing an example of identification of candidate segments and the respective weights of the segments.

FIG. 6A is a representation of partitions in a database.

FIG. 6B is a bipartite graph mapping data from one set of partitions to another set of partitions.

FIG. 7 is a flow diagram of one embodiment of a method of creating a new partitioning.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like may refer to the actions and/or processes of a computing platform, such as a computer or a similar electronic computing device, that manipulates and/or transforms data represented as physical electronic and/or magnetic quantities within the computing platform's memories, registers, and/or other information storage, transmission, and/or display devices.

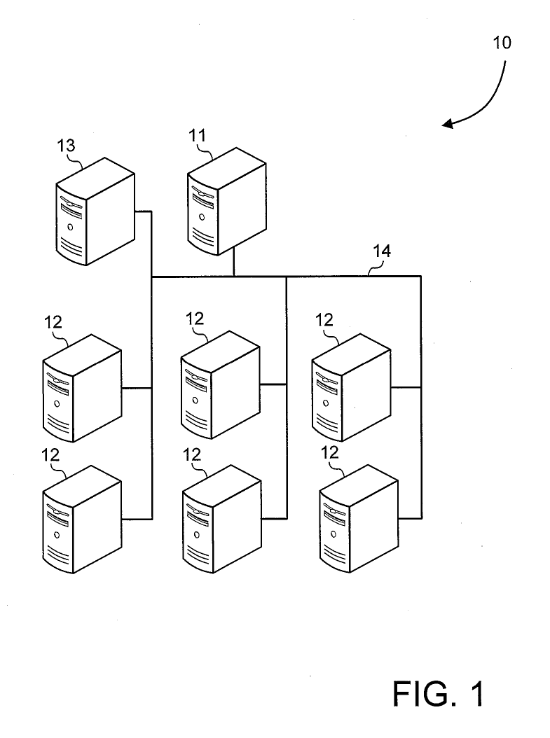

Embodiments described herein relate to, among other things, bulk loading of records into a database. Referring to FIG. 1, in one particular embodiment, although claimed subject matter is not limited in this respect, such database may be broken into a number of partitions stored on a server system 10 comprising a bulk load server 11 and a plurality of data servers 12. Staging server or servers 13 (hereinafter collectively or individually referred to as “staging server 13” for simplicity) may also form part of the server system and may serve to store the data to be bulk loaded into the database.

The data servers 12 may, in turn, comprise one or more computing platforms having a processor, memory and a storage unit such as a hard disk drive, a RAID array of drives, solid state memory configured as a drive or the like. All of the data servers 12 may be collocated and may be connected by a network 14 such as a LAN, or may be located at multiple sites and connected by a WAN or other electronic network 14. The network connection may be wired, wireless, fiber optic or may use other data transmission means or a combination of such means.

In one embodiment, an ordered, distributed database is broken into a plurality of partitions, each partition comprising a plurality of records in a particular key range. One or more of the partitions may be stored on each of the data servers 12. While the number of data servers 12 depicted in FIG. 1 is limited, many data servers 12 may be employed. For example, 100, 200 or 1000 data servers 12 may be employed. Bulk load server 11 may be used to control and coordinate the various stages of the bulk loading process.

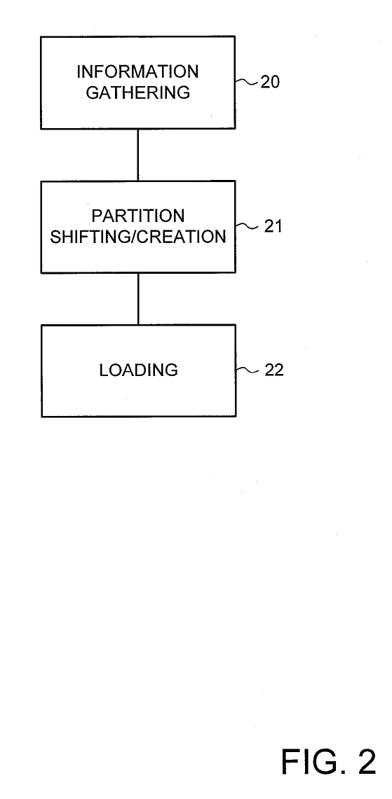

Referring to FIG. 2, and in one embodiment, the bulk loading process may be approached in three stages, namely; an information gathering stage 20, a partition shifting/creation stage 21 and a loading stage 22. In the information gathering stage 20, sampling and histogram techniques may be used to learn about key distribution information in the existing and new records. In the partition shifting/creation stage 21, the information gathered in the information gathering stage 20 is used to select new key boundaries for existing partitions and for new partitions. The information gathered on the new data, which may comprise a large number of new records, may be used to determine the way the partitions will be divided so that the data added in the loading stage 22 may be spread out more or less evenly among partitions of the database and among the servers storing such partitions. In the loading stage 22, the new data records may be sent to the data servers 12 for insertion into the appropriate partitions, resulting in a sorted and balanced distributed database. In one embodiment, this process may reduce the number of existing records that are moved, reduce the number of new records that are moved more than once and/or reduce the shifting of partition key boundaries, as compared to prior methods.

In one embodiment, and as mentioned above, data partitions may hold varying numbers of records. The database design may call for a partition to have a maximum number of records, hypothetically, 10,000 records. The design may call for a desired fill factor of 66%, or 6,600 records, with a target range of ±1,200 records (5,400 records to 7,800 records in the hypothetical). Tighter target ranges for partitions may improve database performance, but may increase database management demands as partition boundaries are changed more frequently to comply with the tighter target ranges.

Where the design size and target ranges of all the partitions are within the above criteria, it may be possible to add small numbers of new records without overfilling any or more than a few partitions. However, as the volume of data to be bulk loaded increases, the likelihood increases that multiple partitions will exceed the target range sizes and that reassignment of partition boundaries and/or creation of new partitions will be required.

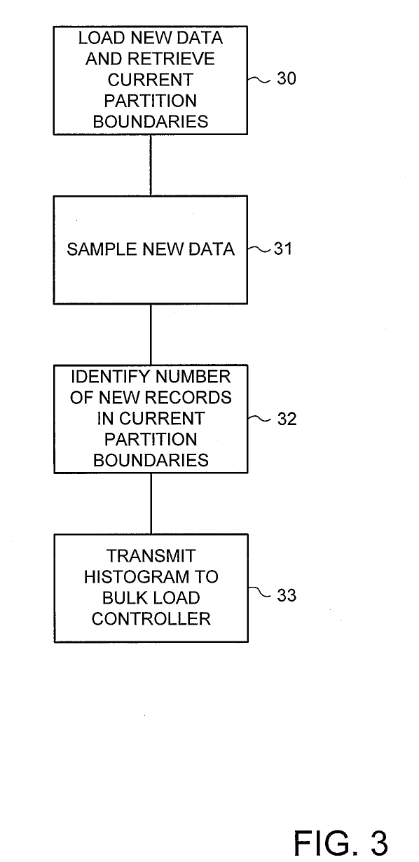

Referring to FIGS. 1-3, and in one embodiment, the information gathering stage 20 may proceed by loading 30 the records to be added to the database (the new records) onto staging server 13. The partition boundaries of the current partitions may also be retrieved and stored in staging server 13.

Staging server 13 in the present embodiment may then sample 31 the new records or otherwise determine their distribution or approximate distribution relative to the partition boundaries. Sampling may also be conducted on the existing database as well to determine its approximate distribution of records. Of course, an exhaustive analysis that reviews each record and produces a complete tally of all records that fall within the boundaries of each current partition would provide more comprehensive information about the distribution of the records comprising the new data, but sampling of the record may be used in the present embodiment to accelerate the process.

In one embodiment, the staging server 13 may then identify 32 the anticipated number of new records to be added to each of the partitions based on the sampling. This data may be in the form of a histogram such as a series of values of records falling within the range of each of the existing partitions in the database. This histogram is then transmitted 33 to the bulk load controller 11 for use in the next stage 21.

One formula that may be employed to determine the sample size per partition is 2*ln(k/p)/(1−1/s)²s where “k” equals the number of current partitions, “p” equals the probability that the sample is representative of the actual distribution of records, and “s” is the skew that represents the acceptable deviation from the fill factor for partitions.

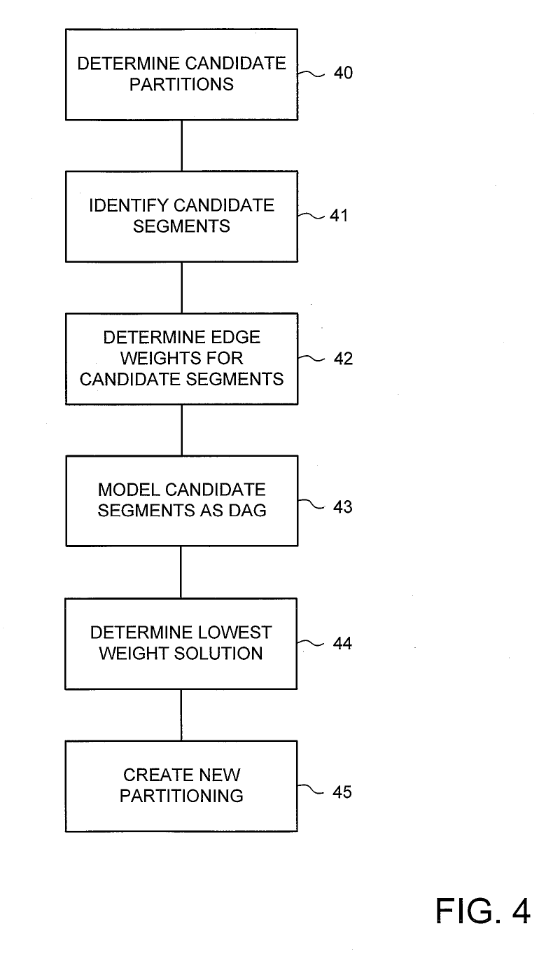

Referring to FIGS. 1, 2 and 4, in one embodiment, with the information on the distribution of the new data with respect to the existing partitions, the bulk load controller 11 may begin the computation of the partition shifts and creations 22 that will be present in the updated version of the database. At this stage, new partition boundaries may be chosen that are projected to result in a distribution of records in the partitions that respects the target partition size and results in partitions with numbers of records that fall within the acceptable ranges. For example, in a database with one thousand old and 500 new records, and a target fill factor of 100 records, the database may be distributed over ten partitions of old records, and a total of fifteen partitions may be needed for the combination of the old and new records.

Stage 21 may proceed with the bulk load controller 13 determining candidate partitions 40. Such candidate partitions may be partitions that have sufficient room within the database design constraints to accommodate the new data records falling within the partition boundaries without overflowing the target range for partition size. If a candidate partition is selected to be carried, the records in the partition may be maintained together and the new data records falling within the boundaries of the partition may simply be added to the partition.

In one embodiment, candidate segments 55 are next identified. Segment 55 are bounded by candidate partitions and comprise the records falling into the interval between the key ranges of the two candidate partitions that bound them. The records in the candidate partitions are not included among the records in the candidate segments. The segments may include non-candidate partitions falling between the candidate partitions. The data falling into a key range between the key ranges of the candidate partitions constitute intervening records (data). Consideration must be given not only for the existing records in the segment, but also for the new data to be added that fall within the segment.

The existing and new records falling into (or, in the case of sampling of the new data, the new records estimated to fall into) the segment 55 may be divisible into one or more partitions that include numbers of records that fall within the target range for allowable record numbers in a partition. In the previous hypothetical database design with a fill factor of 6,600 records and a skew that allows a target range of records of 5,400 to 7,800 records, the allowable number of records in a partition would be between 5,400 and 7,800. If such a division is possible with no existing or new records left over and no partitions overfilled or underfilled, the segment may be considered a candidate segment 55. If no such division of the intervening records can be made, the segment may be rejected as a candidate segment 55.

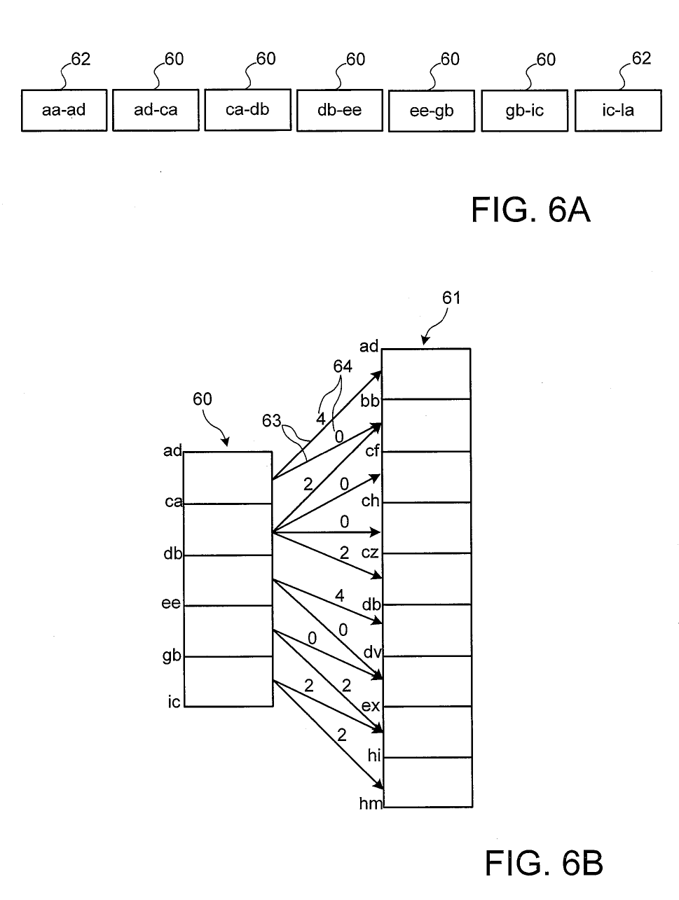

Referring to FIGS. 6A and 6B, and by way of example, a hypothetical partitioning of existing records in a database includes two candidate partitions 62 having key ranges of aa-ad and ic-la respectively. Five other partitions 60 have key ranges that fall between the key range aa-ad and ic-la of the candidate partitions, namely, in this example, key ranges of ad-ca, ca-db, db-ee, ee-gb and gb-ic and form a candidate segment. The fill factor, or target size, for the database in this example is four records per partition. A sampling rate of 50% is chosen and the sample data with keys ad, bb, an, cc, cf, cg, ch, cp, cz, da, db, dm, dv, eq, ex, gm, hi and hm form the sample set.

With eighteen samples taken at a 50% sampling rate, and given the target size, the calculated number of partitions needed to store the data from the partitions 60 of the segment is 9. The sample data may then be broken up, for example, into evenly-sized sets, namely, the keys ad and an, bb and cc, cf and cg, ch and cp, cz and da, db and dm, dv and eq, ex and gm, and hi and hm. The division points chosen between the sets may be used as the boundaries of the new partitions 61 of the candidate segment.

At this stage, it is possible to model the data as a bipartite graph, as in the bulk load controller server 11 or other server. FIG. 6B is a visual representation of such a graph. The old partitions 60 of the segment are represented on the left with the old key boundaries (ie, ad-ca, ca-db, db-ee, ee-gb and gb-ic). The new partitions 61 are represented on the right with key boundaries of ad-bb, bb-cf, cf-ch, ch-cz, cz-db, db-dv, dv-ex, ex-hi and hi-hm. Next, edges 63 may be created between each pair of old and new partitions that have overlap in the key range. For example, the key range ad-ca of the first of the existing partitions 60 overlaps with the key ranges of the first two of the new partitions ad-bb and bb-cf. Accordingly edges 63 are created between the first of the existing partitions 60 and each of the first two of the new partitions 61.

Based on the sampling, it is estimated that four records of the first existing partition 60 will be in the first new partition 61, and that no records of the first existing partition 60 will fall in the second new partition 61 with the key range of bb-cf. The number of records associated with the edges between the old and new partitions 60, 61 may be assigned as weights 64 to the respective edges, or some other number representative of the number of records may be used as weights 64. In the present example, the weight 64 of 4 may be assigned to the first edge 63 between the first existing partition 60 and the first new partition 64.

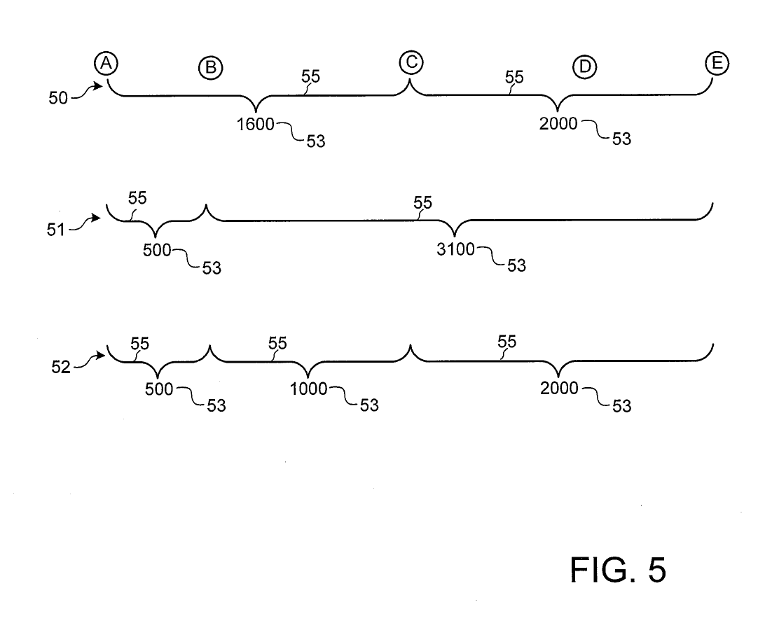

In this form, an implementation of the maximal matching algorithm may be applied to the bipartite graph to find the sum of the weights of the edges 62, representative of the number of records that would not be moved for each of the possible schemes for distributing the records of the five source partitions 60 among the nine target partitions, and to identify the partitioning scheme or schemes having the highest weight, and therefore requiring the moving of the fewest number of records. This solution, that is, this weight representative for record moves for all of the source partitions 60 in a candidate segment may then be used as the weight for the segment, such as the weight 53 of 1600 assigned to the segment represented in FIG. 5 in the first row 50 for the segment falling between candidate partitions A and C.

In one embodiment, with weights assigned to each of the candidate segments 55, the candidate segments 55 may then be modeled to select a set of candidate segments that minimize the number of records to be moved, that is the set of segments with the lowest total weight.

Referring to FIG. 5, five candidate partitions A-E may be used to define candidate segment 55. In row 50, two candidate segment 55 are identified, namely, the segment bounded by partitions A and C, and the segment bounded by partitions C and E. The weights 53 for the candidate segment 55 are shown as 1600 between partitions A and C, and 2000 between partitions C and E. Rows 51 and 52 identify similar segment 55 and their associated weights 53. For example, the sum of the weights for the two candidate segments in row 50 is 1600+2000=3600. The weights 53 identified for the two segments in the second row 51 is 500+3100=3600. Finally, the sum of the weights in the third row 52 is 500+1000+2000=3500. Thus, the partitioning indicated in the third row has the lowest weight, and accordingly would require fewer record moves than would the partitionings indicated in rows 50 or 51.

Referring to FIG. 6, a scheme may be provided for determining the weight of each segment.

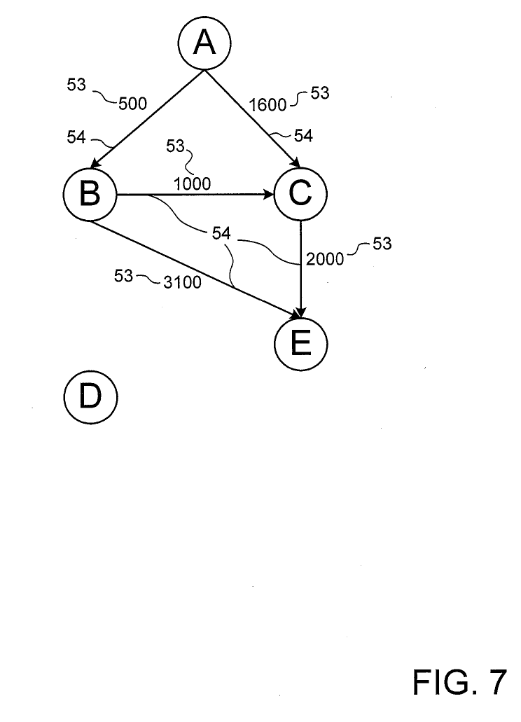

In one embodiment, a lowest weight solution may be computed by modeling the candidate segments 55 using a directed, acyclic graph (a “DAG”) 43. Referring to FIG. 7, in a DAG, the candidate partitions A-E that have been identified may be represented together with edges 54 that represent candidate segment 55. For example, the edge 54 drawn between partitions A and C represents a candidate segment 55 for which the weight 53 is 1600.

The identification of candidate segments 55 did not include any segments beginning or ending with partition D. As such, it will be noted that no edges in the DAG connect D with any of the other candidate partitions. Thus, partition D may not be carried. Of course, as the number of partitions increase, the DAG modeling becomes more complex.

In one embodiment, the determining of the lowest weight solution 44 may be accomplished by solving the DAG modeling of the candidate segment 55. For example, the bulk load server 11 may find a solution using, for example, an implementation of the Dijkstra algorithm, which may be employed to identify the path or paths with the lowest total weight. As discussed in connection with FIG. 5, in the DAG of FIG. 7, the sum of the weights for the segment 55 bounded by partitions A and B, by partitions B and C and, finally, partitions C and E totals 3500, whereas the sum of the weights of the other candidate segment 55 forming a path from A to E are 3600. Thus, the partitions A, B, C and E may be chosen to be carried, and the candidate partition D may be rejected as a candidate partition and not carried.

With this data, the creation of a new partitioning of the database 45 can be accomplished. The carried partitions A, B, C, and E may remain intact, and the intervening records may be reallocated among existing intervening partitions and newly created partitions. Previously-existing, non-carried partitions may have portions of their records shifted to new partitions, and new partitions may be created to accommodate some of the current and new records.

Once the new partitioning scheme is developed, the record moves and the key range reassignments of the partitions may be made. At this point, in one embodiment, the loading 22 of the new data may commence by the staging server 13 being directed to transfer portions of the new data to the data server 12 on which the partition having a key range that encompasses the range of keys of that portion of the new data. This may proceed until all of the new data has been transmitted to the appropriate data servers 12. The data servers 12 may then insert the new data into the appropriate partitions.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method of updating a multi-partition distributed database with new data comprising:
analyzing the distribution of a batch of new data relative to partition boundaries of a database to produce values representative of a distribution of the new data relative to the partition boundaries;
creating a new partitioning by adjusting partition boundaries based, at least in part, on the values; and
loading the new data into the partitions.

2. The method of claim 1 wherein the analyzing of the new data comprises:
sampling the new data; and
calculating for at least one of said partitions a value representative of the quantity of new data to be added to said partition based, at least in part on the sampling.

3. The method of claim 1 wherein creating of the new partitioning comprises:
identifying candidate partitions; and
analyzing the distribution of old and new data for a candidate partition to determine new partition boundaries for the existing data.

4. The method of claim 3 wherein creating of the new partitioning comprises:
computing edge weights representing an amount of data that would be moved in order to achieve repartitioning of the data in the candidate segments;
modeling the candidate partitions and data falling between the candidate partitions as a directed acyclic graph with vertices representing candidate partitions, and edges representing intervals between candidate partitions, and assigning an edge weight to each of a plurality of edges; and
calculating the lowest weight path for combinations of candidate segments.

5. The method of claim 4 wherein computing of edge weights for a candidate segment comprises;
calculating the weights for a plurality of partitionings of the candidate segment;
identifying the lowest calculated weight path based on the modeling.

6. The method of claim 5 wherein a maximal matching algorithm is used in identifying the lowest weight path for repartitioning a candidate segment and wherein Dijkstra's algorithm is used in calculating the lowest weight path for combinations of candidate segments.

7. The method of claim 1 wherein loading the new data comprises transferring portions of new data with key numbers within the boundaries of a partition to the data server storing such partition.

8. An apparatus comprising:
A server system comprising a plurality of networked data servers, the data servers each storing at least one of a plurality of partitions of which the database is comprised, the server system being adapted to:
analyze the distribution of a batch of new data relative to partition boundaries of the database to produce values representative of a distribution of the new data relative to the partition boundaries;
create a new partitioning of the database partitions by adjusting partition boundaries based, at least in part, on the values; and
load the new data into the partitions.

9. The apparatus of claim 8 wherein the analyzing of the batch of new data comprises:
sampling the new data; and
calculating for at least one of said partitions a value representative of the quantity of new data to be added to said partition based, at least in part on the sampling.

10. The apparatus of claim 8 wherein creating the new partitioning comprises:
identifying candidate partitions; and
analyzing the distribution of old and new data for a candidate partition to determine new partition boundaries for the existing data.

11. The method of claim 10 wherein creating of the new partitioning comprises:
computing edge weights representing an amount of data that would have to be moved in order to achieve repartitioning of the data in the candidate segments;
modeling the candidate partitions and data falling between the candidate partitions as a directed acyclic graph with vertices representing candidate partitions, and edges representing intervals between candidate partitions, and assigning an edge weight to each of a plurality of edges; and
calculating the lowest weight path for combinations of candidate segments.

12. The apparatus of claim 11 computing of edge weights for a candidate segment comprises;
calculating the weights for a plurality of partitionings of the candidate segment;
identifying the lowest calculated weight path based on the modeling.

13. The apparatus of claim 12 wherein a maximal matching algorithm is used in identifying the lowest weight path for repartitioning a candidate segment and wherein Dijkstra's algorithm is used in calculating the lowest weight path for combinations of candidate segments.

14. The apparatus of claim 8 wherein loading the new data comprises transferring portions of new data with key numbers within the boundaries of a partition to the data server storing such partition.

15. An article comprising:
a storage medium comprising machine readable instructions stored thereon which, if executed by a computing platform, are adapted to cause said computing platform to perform the method:
analyzing the distribution of a batch of new data relative to partition boundaries of the database to produce values representative of a distribution of the new data relative to the partition boundaries;
creating a new partitioning of the database partitions by adjusting partition boundaries based, at least in part, on the values; and
loading the new data into the partitions.

16. The article of claim 15 wherein analyzing of the new data comprises:
sampling the new data; and
calculating for at least one of said partitions a value representative of the quantity of new data to be added to said partition based, at least in part on the sampling.

17. The article of claim 15 wherein creating of the new partitioning comprises:
identifying candidate partitions; and
analyzing the distribution of old and new data for a candidate partition to determine new partition boundaries for the existing data.

18. The method of claim 17 wherein creating of the new partitioning comprises:
computing edge weights representing an amount of data that would have to be moved in order to achieve repartitioning of the data in the candidate segments;
modeling the candidate partitions and data falling between the candidate partitions as a directed acyclic graph with vertices representing candidate partitions, and edges representing intervals between candidate partitions, and assigning an edge weight to each of a plurality of edges; and
calculating the lowest weight path for combinations of candidate segments.

19. The method of claim 18 wherein the calculating of the lowest weight path comprises;
calculating the weights for a plurality of partitionings of the candidate segment;
identifying the lowest calculated weight path based on the modeling.

20. A method of updating a multi-partition distributed database with new data comprising:
analyzing the distribution of a batch of new data relative to partition boundaries of a database to produce values representative of a distribution of the new data relative to the partition boundaries, wherein the analyzing comprises;
sampling the new data; and
calculating for at least one of said partitions a value representative of the quantity of new data to be added to said partition based, at least in part on the sampling;
creating a new partitioning by adjusting partition boundaries based, at least in part, on the values, wherein the creating a new partitioning further comprises;
identifying candidate partitions,
analyzing the distribution of old and new data for a candidate partition to
determine new partition boundaries for the existing data, computing edge weights representing an amount of data that would have to be moved in order to achieve repartitioning of the data in the candidate segments;
modeling the candidate partitions and data falling between the candidate partitions as a directed acyclic graph with vertices representing candidate partitions, and edges representing intervals between candidate partitions, and assigning an edge weight to each of a plurality of edges, and
calculating the lowest weight path for combinations of candidate segments; and
loading the new data into the partitions, the loading comprising transferring new data falling within the boundaries of a partition to the data server storing such partition;
wherein identifying the lowest weight path for repartitioning a candidate segment is accomplished using a maximal matching algorithm and wherein calculating the lowest weight path for combinations of candidate segments is accomplished using Dijkstra's algorithm.
